(19) United States
(12) Patent Application Publication
(10) Pub. No.: US 2008/0192501 A1
(43) Pub. Date: Aug. 14, 2008

(54) System and method for displaying images

(75) Inventors: Terry A. Bartlett, Dallas, TX (US); Sajjad Ali Khan, Plano, TX (US)

Correspondence Address: TEXAS INSTRUMENTS INCORPORATED, P O BOX 655474, M/S 3999, DALLAS, TX, 75265, US

(73) Assignee: Texas Instruments Incorporated

(21) Appl. No.: 11/705,640

(22) Filed: Feb. 12, 2007

(51) Int. Cl. F21V 8/00

(52) U.S. Cl. 362/606

(57) ABSTRACT

System and method for reducing visible speckle in images displayed using coherent light. An embodiment comprises a first layer in a light path of a display plane, the first layer collimates and diffuses light passing through the first layer from a light source side of the display plane along the light path, an actuator coupled to the first layer, the actuator moves the first layer in plane orthogonal to the light path, and a second layer in the light path on a viewing side of the display plane, the second layer increases a viewing angle of the display plane. The actuator continuously moves the first layer so that the light passing through the first layer is diffused to reduce the appearance of speckles.

### TECHNICAL FIELD

The present invention relates generally to a system and method for displaying images, and more particularly to a system and method for reducing visible speckle in images displayed using coherent light.

### BACKGROUND

Coherent light, such as light produced by a laser, may be used to replace a wideband light (light that encompasses a wide range of wavelengths) produced by a lamp and/or a narrowband light (light that encompasses a small range of wavelengths) produced by a light emitting diode (LED) in projection display systems. When a wideband light is used in a projection display system, a color filter may generally be used to create light with desired colors (wavelengths). The use of a narrowband light source may eliminate the color filter. For example, in a projection display system, such as a microdisplay-based projection display system, coherent light at desired wavelengths produced by multiple lasers may replace a wideband light produced by an electric arc lamp that requires a color filter to produce the desired colors of light. Furthermore, the coherent light from lasers may typically be brighter than light produced by LEDs. Therefore, a reduction in the size of an illumination system used in the microdisplay-based projection display system may be realized with a reduction in the number of LEDs and the elimination of the color filter.

Coherent light may be used to illuminate a digital micromirror device (DMD), a form of microdisplay, of a microdisplay-based projection display system. The DMD may contain a large number of micromirrors arranged in an array. The micromirrors in the DMD are typically in one of two states (positions) depending on data from an image being displayed. In a first state, a micromirror may reflect the coherent light onto a display plane, and in a second state, the micromirror may reflect the coherent light away from the display plane. The coherent light reflecting off the large number of micromirrors combines to create the image on the display plane.

When coherent light is scattered by a rough surface, such as a display plane, a modulating spatial noise with high contrast may be produced. The modulating spatial noise, commonly referred to as speckle, may be highly objectionable to viewers. Light fields from each individual scatterer may add coherently and sum as phasors resulting in a randomly varying intensity across the display plane.

### SUMMARY OF THE INVENTION

These and other problems are generally solved or circumvented, and technical advantages are generally achieved, by embodiments of the present invention which provide a system and a method for reducing visible speckle in images displayed using coherent light.

In accordance with an embodiment, a display plane is provided. The display plane has a light source side and a viewing side. The display plane includes a first layer in a light path of the display plane, an actuator coupled to the first layer, and a second layer in the light path on the viewing side of the display plane. The first layer collimates and diffuses light passing through the first layer from the light source side along the light path and the second layer increases a viewing angle on the viewing side of the display plane. The actuator moves the first layer in plane orthogonal to the light path.

In accordance with an embodiment, a display system is provided. The display system includes a light source to produce coherent light, an array of light modulators optically coupled to the light source and positioned in a light path of the light source after the light source, a display plane positioned in the light path after the array of light modulators, and a controller electronically coupled to the array of light modulators and to the light source. The array of light modulators produces images by modulating light from the light source based on image data and the controller loads image data into the array of light modulators. The display plane includes an optical diffusing unit in the light path, the optical diffusing unit bends and scatters light passing through the optical diffusing unit along the light path, an actuator coupled to the optical diffusing unit, the actuator moves the optical diffusing unit in a plane orthogonal to the light path, and a second layer in the light path after the optical diffusing unit, the second layer increases a viewing angle of the display plane.

In accordance with another embodiment, a method for manufacturing a display system is provided. The method includes installing a light source configured to generate coherent light, installing an array of light modulators in a light path of the display system after the light source, and installing a controller configured to control the light source and the array of light modulators. The method also includes installing a display plane in the light path of the display system after the array of light modulators, where the display plane installing includes installing an optical diffusing unit to collimate and diffuse light, installing an actuator coupled to the optical diffusing unit, and installing an optical diffusing layer.

An advantage of an embodiment is that a second diffuser, used for speckle reduction, may be combined with one of two lens elements typically found in a display plane of a microdisplay-based projection display system to create a single unit. The single unit may simplify the manufacture of the microdisplay-based projection display system, thereby potentially reducing its cost while increasing reliability.

A further advantage of an embodiment is that the use of the single unit in the display plane may permit the use of a simpler technique to provide the desired movement while maintaining the proper alignment needed for the display of images.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiments disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the embodiments, and the advantages thereof, reference is now made to the following descriptions taken in conjunction with the accompanying drawings, in which:

FIGS. 1a and 1b are diagrams of different views of an exemplary DMD-based projection display system;

FIGS. 2a and 2b are diagrams of a side view and an isometric view of a display plane;

FIGS. 3a through 3f are diagrams of exemplary display planes;

FIGS. 4a through 4c are diagrams of exemplary movements of the optical diffusing unit;

FIGS. 5a through 5f are diagrams of detailed side views of portions of the optical diffusing unit; and

FIG. 6 is a diagram of a sequence of events in the manufacture of a microdisplay-based projection display system.

### DETAILED DESCRIPTION OF ILLUSTRATIVE EMBODIMENTS

The making and using of the embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

The embodiments will be described in a specific context, namely a DMD-based projection display system. The invention may also be applied, however, to projection display systems, in general, and specifically to other microdisplay-based projection display systems, such as those utilizing transmissive or reflective liquid crystal displays, liquid crystal on silicon, ferroelectric liquid-crystal-on-silicon, deformable micromirrors, and so forth.

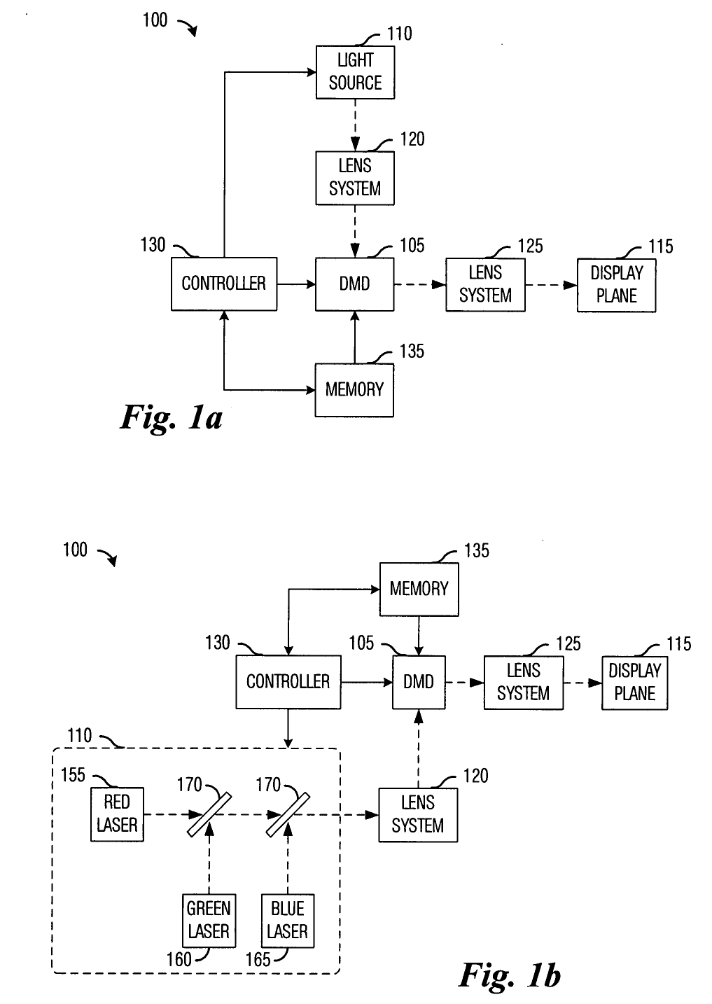

With reference now to FIGS. 1a and 1b, there are shown diagrams illustrating views of an exemplary DMD-based projection display system. The diagram shown in FIG. 1a illustrates a high-level view of a DMD-based projection display system 100, which includes a DMD 105 that modulates light produced by a light source 110. The DMD 105 is an example of a microdisplay. Other examples of microdisplays may include transmissive or reflective liquid crystal, liquid crystal on silicon, deformable micromirrors, and so forth. In a microdisplay, an array of light modulators may be arranged in a rectangular, square, diamond shaped, and so forth, array. Each light modulator in the microdisplay may operate in conjunction with the other light modulators to modulate the light produced by the light source 110. The light, modulated by the DMD 105, may be used to create images on a display plane 115. The DMD-based projection display system 100 also includes a first lens system 120, which may be used to collimate the light produced by the light source 110 as well as collect stray light, and a second lens system 125, which may be used to manipulate (for example, focus), the light reflecting off the DMD 105.

The DMD 105 may be coupled to a controller 130, which may be responsible for loading image data into the DMD 105, controlling the operation of the DMD 105, controlling the light produced by the light source 110, and so forth. A memory 135, which may be coupled to the DMD 105 and the controller 130, may be used to store the image data, as well as configuration data, color correction data, and so forth.

The diagram shown in FIG. 1b illustrates a high-level view of the DMD-based projection display system 100 with added emphasis on the light source 110. The light source 110 of the DMD-based projection display system 100 may utilize a plurality of lasers to produce coherent light at different wavelengths. A red laser 155, for example, may produce coherent light in the red color spectrum. Similarly, a green laser 160 and a blue laser 165, may produce coherent light in the green and blue color spectra, respectively. The light source 110 may include dichroic filters 170. The dichroic filters 170 reflect light of certain frequencies while they transmit light at other frequencies. The dichroic filters 170 may be used to combine the coherent light produced by the multiple lasers into a single light path 175.

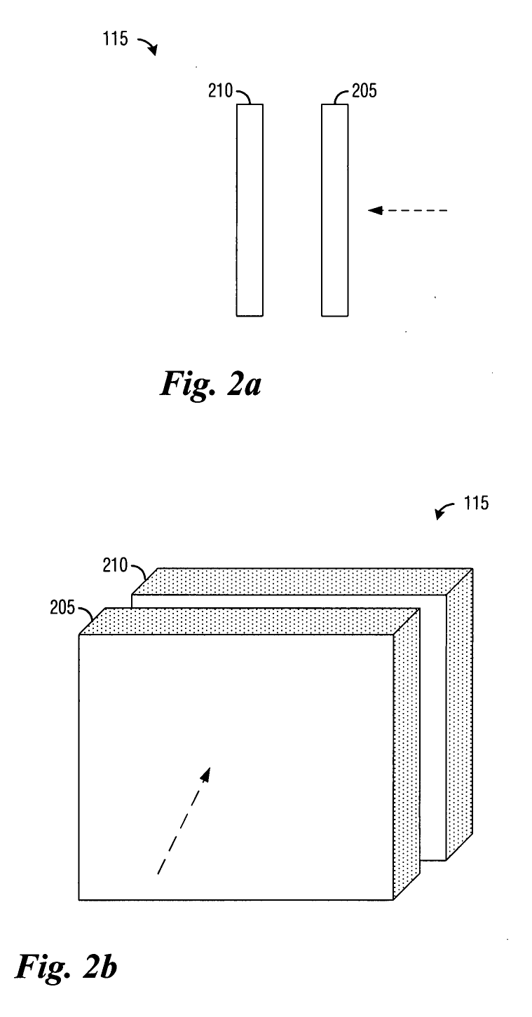

With reference now to FIGS. 2a and 2b, there are shown diagrams illustrating a side view and an isometric view of the display plane 115. The display plane 115 of a microdisplay-based projection display system may comprise two layers. A first layer 205, located closer to the microdisplay, for example, the DMD 105, may be used to bend the modulated light arriving from the microdisplay to create light beams that are substantially parallel to a light path (shown as a dashed arrow) through the display plane 115. A Fresnel lens may be an example of the first layer 205. A second layer 210 may be a diffusion layer and may be used to manipulate the light beams to increase the viewing angle of the microdisplay-based rear-projection display system, with a lenticular layer and a one- or two-dimensional tiny prism arrays being examples of the second layer 210. The first layer 205 and the second layer 210 may be separated by an air gap or they may be placed in contact with each other, either directly or through an alternate medium, such as a refractively similar fluid, solid, or glue.

The ability to reduce speckle in a microdisplay-based projection display system using coherent light illumination may be limited by the resolution of lenses used in the lens system, such as a projection lens, which may depend on the etendue of the microdisplay. The approximate speckle size at the display plane 115 for an exemplary microdisplay-based projection display system may be expressed as:

λ*F_{#}_{_{DMD}}*magnification,

where λ is the wavelength of the coherent light, F_{#}_{_{DMD}} is a ratio of the focal length to the aperture of a projection lens located in the second lens system 125 of the microdisplay-based projection display system, and magnification is the magnification of the projection lens in the lens system.

A diffusion layer inserted in the light path of the microdisplay-based projection display system can help to reduce the speckle size, thereby enabling a greater reduction in the speckle. The approximate speckle size at the display plane 115 with a diffusion layer inserted in the light path may be expressed as:

$$\frac{λ}{{θ}_{diffusion\_layer}} ,$$

where θ_{diffusion}_{_{—}}_{layer} is the scatter angle of the diffusion layer.

Again, the addition of the diffusion layer may help to reduce the size of the speckle. However, a reduction in the size of the speckle may not be sufficient to make the speckle less noticeable. A moving diffusion layer may help to make the speckle less noticeable by changing the speckle pattern at a sufficient frequency so that a viewer's eye may average the speckle patterns in time. The averaging of the speckle patterns may reduce the overall visibility of the speckle pattern. Furthermore, smaller sized speckles may allow for better overall speckle reduction due to the larger number of speckles on the image as viewed by the viewer.

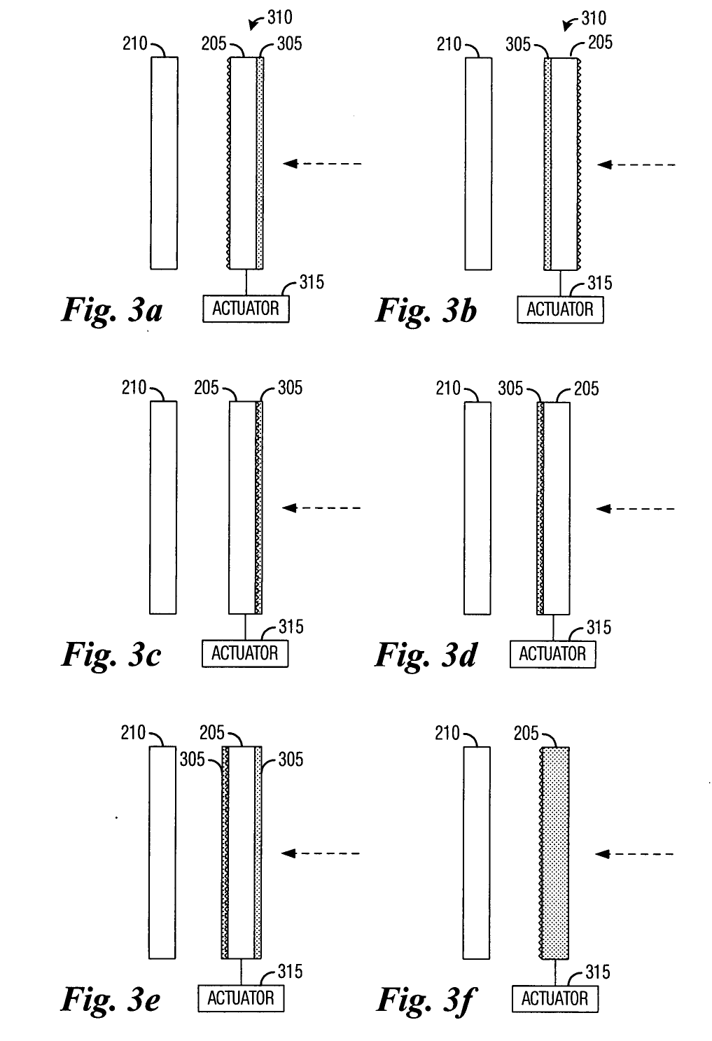

With reference now to FIGS. 3a through 3f, there are shown diagrams illustrating side views of exemplary display planes for use in microdisplay-based projection display systems utilizing coherent illumination. The diagram shown in FIG. 3a illustrates a display plane that includes a first layer 205 and a second layer 210, with the first layer 205 comprising a Fresnel lens and the second layer 210 comprising a lenticular layer 210 (or a tony prism array). Coupled to the first layer 205 may be a diffusion layer 305. Preferably, the diffusion layer 305 may be a diffuser with a diffusion angle ranging from about 0.5 degrees to about 20 degrees, with about 5 degrees to about 10 degrees preferred. However, the diffusion layer 305 may be formed from a diffuser with diffusion angles ranging from less than about 5 degrees to greater than about 10 degrees.

The first layer 205 and the diffusion layer 305 may be arranged so that they form a single optical diffusing unit 310. The optical diffusing unit 310 may be moved by an actuator 315. The actuator 315, for example, a DC brushless motor, a piezoelectric motor, and so forth, may be connected to the optical diffusing unit 310. Additionally, the actuator 315 may be a solid state actuator, such as one created from an electrostrictive material that expands and contracts based on an applied electric field.

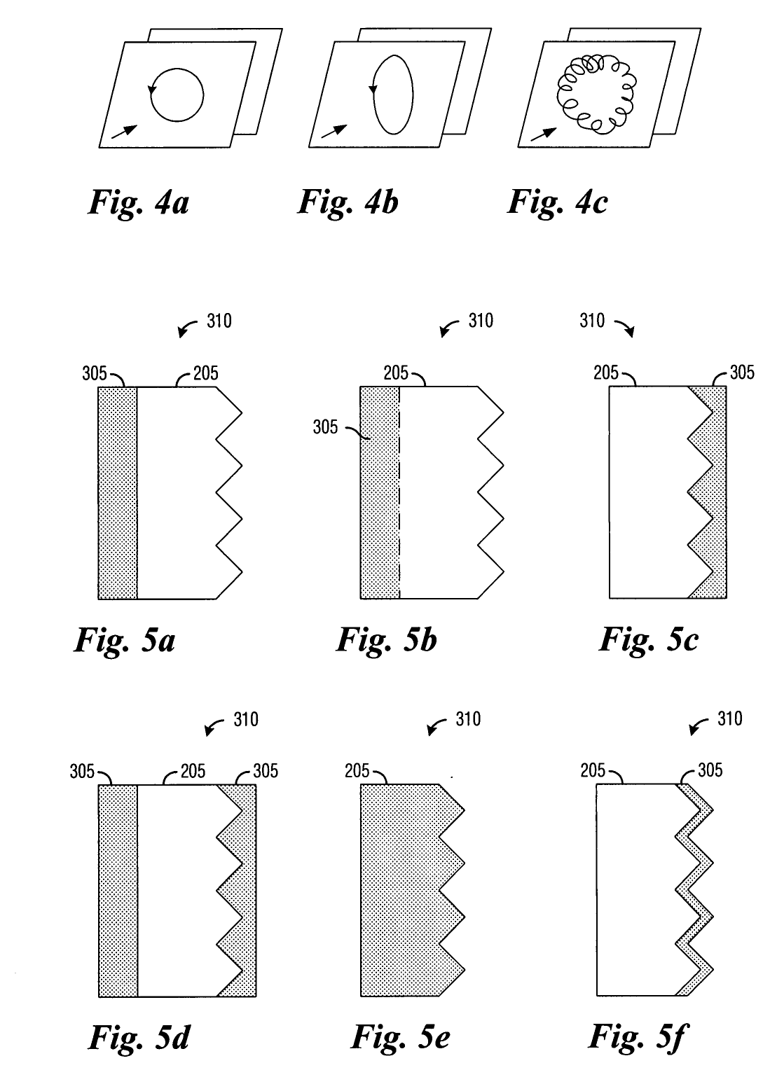

According to an embodiment, the actuator 315 may move the optical diffusing unit 310 in a circular pattern either clockwise or counter-clockwise, with a small displacement, for example, about one (1) to about two (2) millimeters or from about 0.5 to about two (2) millimeters with a low frequency of about one to about four (or more) Hertz. Alternatively, the optical diffusing unit 310 may be moved in an oval shaped pattern either clockwise or counter-clockwise, an alternating decreasing and increasing spiral pattern, a random orbital pattern, a linear pattern, and so forth. FIGS. 4a through 4c display exemplary counter-clockwise circular and oval shaped patterns and an exemplary circular pattern with integral random spiral pattern. The movement of the optical diffusing unit 310 may be orthogonal to the light path of the display plane. However, the optical diffusing unit 310 may also be moved longitudinally along the light path of the display plane. Additionally, movement of the optical diffusing unit 310 may contain orthogonal and longitudinal components with respect to the light path. The light path may be reference to light beams as they leave the display plane.

The optical diffusing unit 310 may be preferred over a disjoint first layer 205 and the diffusion layer 305 since a single unit (the optical diffusion unit 310) may suffer less light transmission loss since there may be two fewer air/optical material interfaces that may potentially cause a reduction in light transmission. Additionally, a reduction in the number of components may help increase system reliability and performance due to component misalignment or improper alignment.

The diagram shown in FIG. 3a illustrates the optical diffusing unit 310 with the diffusion layer 305 formed on the side of the first layer 205 closer to the light source of the microdisplay-based projection display system. The diagram shown in FIG. 3b illustrates an optical diffusing unit 310 wherein the diffusion layer 305 is formed on the side of the first layer 205 further from the light source of the microdisplay-based projection display system.

A Fresnel lens may be used as the first layer 205. In a typical Fresnel lens, a first surface may have a series of grooves and a second surface may be smooth. The diagrams shown in FIGS. 3a and 3b illustrate embodiments wherein the diffusion layer 305 is formed on the smooth surface of the Fresnel lens. However, the diffusion layer 305 may be formed on the grooved surface of the Fresnel lens, as shown in the diagrams shown in FIGS. 3c and 3d.

Additionally, the diffusion layer 305 may be formed on both surfaces of the first layer 205, as shown in the diagram shown in FIG. 3e. The optical units shown in FIGS. 3a through 3e have been formed on one or both surfaces of the first layer 205. It may also be possible to form the first layer 205 from a material with the desired optical diffusion properties as the diffusion layer 305 and potentially eliminate the need to form the diffusion layer 305 on the first layer 205 altogether. A first layer 205 formed from a material with the desired optical diffusion properties is shown in FIG. 3f.

With reference now to FIGS. 5a through 5f, there are shown diagrams illustrating detailed side views of portions of alternate embodiments of the optical diffusing unit 310. The diagrams shown in FIGS. 5a through 5f illustrate a particular orientation of the optical diffusing unit 310, namely, with the optical diffusing unit 310 oriented so that the grooved side of a Fresnel lens used as the first layer 205 is oriented towards the light source of the microdisplay-based projection display system. However, similar diagrams may be created to illustrate an optical diffusing unit with the grooved side of a Fresnel lens oriented away from the light source.

The diagram shown in FIG. 5a illustrates the optical diffusing unit 310 comprising the first layer 205 and the diffusion layer 305, wherein the diffusion layer 305 and the first layer 205 may be attached together to form a single unit. A glue may be used to attach the two layers, wherein the glue preferably has about the same optical refractive index as the materials used in the diffusion layer 310 and the first layer 205. Rather than gluing two separate layers together, the optical diffusing unit 310 shown in FIG. 5b may be formed by directly forming the diffusion layer 305 on the first layer 205 (or vice versa). For example, the diffusion layer 305 may be formed by depositing a diffusion material in liquid form over the first layer 205 and then pressing the diffusion layer 305 to desired thickness and finish. Alternatively, the first layer 205 may be formed by depositing a material used to create the first layer 205 over the diffusion layer 305 and then pressing the desired grooves into the material to form the first layer 205.

The diagram shown in FIG. 5c illustrates the optical diffusing unit 310 with the diffusion layer formed on the grooved side of the first layer 205. The optical diffusing unit 310 may be formed by depositing a diffusion material in liquid form over the first layer 205 and then pressing the diffusion layer 305 to desired thickness and finish. The diffusion layer 305 may be formed on both sides of the first layer 205, as shown in the diagram shown in FIG. 5d, or the first layer 205 may be formed from a material that possesses the light diffusion properties of the material used in the diffusion layer, thereby eliminating a separate diffusion layer, as shown in the diagram shown in FIG. 5e.

The diagram shown in FIG. 5f illustrates the optical diffusing unit 310 with the diffusion layer 305 formed in such a way that the grooves in the first layer 205 are substantially preserved by the diffusion layer 305. Combinations of various configurations of the optical diffusing unit 310 may be possible. For example, an additional diffusion layer may be formed on the smooth side of the first layer 205 of the optical diffusing unit 310 shown in FIG. 5f, an additional diffusion layer may be formed on the grooved side of the first layer 205 of the optical diffusing unit 310 shown in FIG. 5b, the diffusion layer 305 on the smooth side of the first layer 205 of the optical diffusing unit 310 shown in FIG. 5d may be formed as shown in FIG. 5b, and so forth.

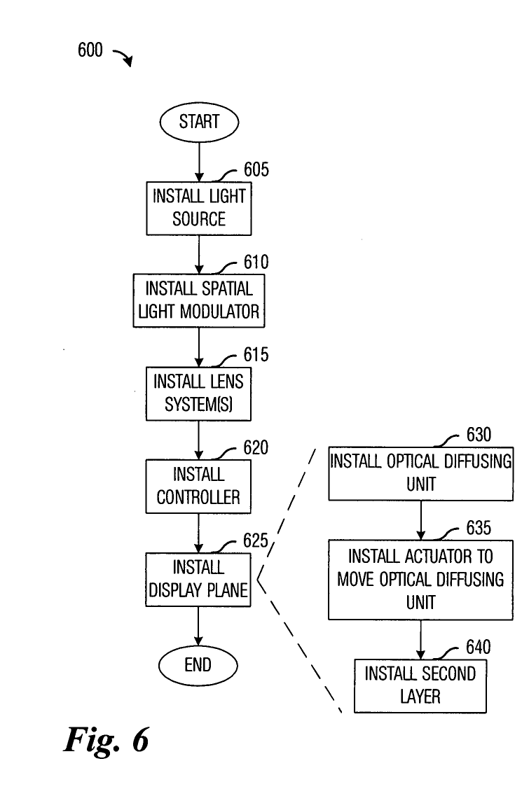

With reference now to FIG. 6, there is shown a diagram illustrating a sequence of events 600 in the manufacture of an exemplary microdisplay-based projection display system. The manufacture of the microdisplay-based projection display system may begin with installing a light source, which may produce multiple colors of light (block 605). The manufacture may continue with installing a microdisplay, such as a DMD, in the light path of the multiple colors of light produced by the light source (block 610). After installing the microdisplay, a lens system may be installed in between the light source and the microdisplay (block 615). A controller for the microdisplay-based projection display system may then be installed (block 620).

With the controller installed, the manufacture may continue with installing a display plane (block 625). The installing of the display plane may include the installing of an optical diffusing unit, such as the optical diffusing unit 310 (block 630), followed by an actuator to move the optical diffusing unit (block 635) and a second layer, such as the second layer 210 (block 640). The order of the events in this sequence may be changed, the sequence may be performed in a different order, or some of the steps may be performed at the same time to meet particular manufacturing requirements of the various embodiments of the display plane, for example.

Although the embodiments and their advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A display plane having a light source side and a viewing side, the display plane comprising:
a first layer in a light path of the display plane, the first layer configured to collimate and diffuse light passing through the first layer from the light source side along the light path;
an actuator coupled to the first layer, the actuator configured to move the first layer in a plane orthogonal to the light path of the display plane; and
a second layer in the light path on the viewing side of the display plane, the second layer configured to increase a viewing angle on the viewing side of the display plane.

2. The display plane of claim 1, wherein the first layer comprises:
a lens layer configured to collimate light; and
a diffusion layer coupled to the lens layer.

3. The display plane of claim 2, wherein the lens layer comprises a Fresnel lens.

4. The display plane of claim 2, wherein the diffusion layer and the lens layer are formed separately and bonded together to form a single unit.

5. The display plane of claim 2, wherein the lens layer is formed over the diffusion layer.

6. The display plane of claim 2, wherein the diffusion layer has a diffusion angle ranging from approximately 0.5 degrees to approximately 20 degrees.

7. The display plane of claim 1, wherein the first layer comprises a Fresnel lens formed from a material with a light diffusion property.

8. The display plane of claim 1, wherein the actuator moves the first layer in a pattern selected from a group consisting of: a circular pattern, an oval pattern, a circular spiral, random orbital, linear, or combinations thereof.

9. The display plane of claim 8, wherein a displacement of the first layer by the actuator ranges from about 0.5 millimeters to about 4 millimeters.

10. The display plane of claim 1, wherein the first layer and the second layer are separated by a gap filled with a material selected from a group consisting of: air, liquid, solid, or combinations thereof.

11. The display plane of claim 1, wherein the second layer comprises a lenticular layer.

12. A display system comprising:
a light source to produce coherent light;
an array of light modulators optically coupled to the light source and positioned in a light path of the light source after the light source, the array of light modulators configured to produce images by modulating light from the light source based on image data;
a display plane positioned in the light path after the array of light modulators, the display plane configured to display the images produced by the array of light modulators, the display plane comprising
an optical diffusing unit in the light path, the optical diffusing unit configured to bend and scatter light passing through the optical diffusing unit layer along the light path,
an actuator coupled to the optical diffusing unit, the actuator configured to move the optical diffusing unit in a plane orthogonal to the light path,
a second layer in the light path after the optical diffusing unit, the second layer configured to increase a viewing angle of the display plane; and
a controller electronically coupled to the array of light modulators and to the light source, the controller configured to load image data into the array of light modulators.

13. The display system of claim 12, wherein the light source comprises multiple lasers.

14. The display system of claim 12, wherein the optical diffusing unit comprises:
a lens layer configured to bend light; and
a diffusion layer coupled to the lens layer, the diffusion layer configured to scatter light.

15. The display system of claim 14, wherein the lens layer comprises a Fresnel lens, and wherein the Fresnel lens is formed over the diffusion layer.

16. The display system of claim 12, wherein the array of light modulators comprises a digital micromirror device.

17. A method of manufacturing a display system, the method comprising:
installing a light source configured to generate coherent light;
installing an array of light modulators in a light path of the display system after the light source;
installing a controller configured to control the light source and the spatial light modulator; and
installing a display plane in the light path of the display system after the array of light modulators, wherein the display plane installing comprises
installing an optical diffusing unit configured to collimate and diffuse light,
installing an actuator coupled to the optical diffusing unit, and
installing an optical diffusing layer.

18. The method of claim 17, wherein the light source comprises a plurality of lasers, with each respective laser capable of producing a color of coherent light, the method further comprising installing a plurality of light guides configured to combine coherent light produced by each respective laser with coherent light produced by other lasers.

19. The method of claim 17, wherein the optical diffusing unit comprises a Fresnel lens and a diffusion layer, and wherein Fresnel lens is formed by depositing a lens material in liquid form over the diffusion layer and then molding a desired shape for the Fresnel lens.

20. The method of claim 17, wherein the optical diffusing unit comprises a Fresnel lens and a diffusion layer, and wherein the diffusion layer is formed by depositing a diffusion material over the Fresnel lens and then molding a desired shape for the diffusion layer.
